(19) United States
(12) Patent Application Publication
(10) Pub. No.: US 2014/0065663 A1
(43) Pub. Date: Mar. 6, 2014

(54) METHODS FOR EVALUATING QUANTIFYING FIBROSIS IN LUNG TISSUE

(71) Applicant: Numira Biosciences, Inc., Salt Lake City, UT (US)

(72) Inventors: Sergio Vasquez, South Jordan, UT (US); Neha Shah, Salt Lake City, UT (US); David Weinstein, Salt Lake City, UT (US)

(73) Assignee: Numira Biosciences, Inc., Salt Lake City, UT (US)

(21) Appl. No.: 14/020,462

(22) Filed: Sep. 6, 2013

Related U.S. Application Data
(60) Provisional application No. 61/697,459, filed on Sep. 6, 2012.

(51) Int. Cl. G01N 21/17

(52) U.S. Cl. CPC G01N 21/17
USPC 435/29

(57) ABSTRACT

The present disclosure relates in general to methods for staining and imaging lung specimens for the purpose of quantifying fibrotic areas of the lung. Images according to the present invention include images obtained from X-ray microcomputed tomography.

### CROSS REFERENCE TO RELATED APPLICATIONS

This application claims the benefit of U.S. Provisional Application Ser. No. 61/697,459, filed Sep. 6, 2012, which is incorporated herein by reference in its entirety.

### FIELD OF THE INVENTION

The present application relates generally to methods for detecting, evaluating, and quantifying fibrotic tissue in lung tissues, where the lung tissue is stained and imaged using X-ray microcomputed tomography (microCT).

### BACKGROUND

Fibrosis is the formation or development of excess fibrous connective tissue in a tissue or organ. Pulmonary fibrosis is the formation of fibrous connective tissue in the lungs of an organism, which may also be described as scarring of the lung. Pulmonary fibrosis may be a secondary effect of a disease or condition, may be related to an environmental factor, or could occur without any known cause. Example causes of pulmonary fibrosis include autoimmune disorders, viral infections, or other microscopic injuries to the lung. However, pulmonary fibrosis can also be idiopathic, or appearing without any known cause. Idiopathic cases are believed to be related to a genetic predisposition.

Environmental causes of pulmonary fibrosis can include inhalation of environmental and occupational pollutants, such as asbestosis or silicosis and exposure to certain gases. Coal miners, ship workers, sand blasters, and other industrial workers are among those that are at higher risk. Individuals who also inhale dust contaminated with bacterial, fungal, or animal products can also develop pulmonary fibrosis. Besides environmental causes, other diseases can lead to the development of pulmonary fibrosis. These can include rheumatoid arthritis, SLE, scleroderma, sarcoidosis, and Wegener's granulomatosis. Cigarette smoking can increase the risk or further cause pulmonary fibrosis. Beyond environmental causes or diseases, certain medications, for example amiodarone, bleomycin, busulfan, methotrexate, and nitrofurantoin, have also been discovered to cause pulmonary fibrosis.

The bio-medical research community is aggressively investigating new treatments for pulmonary fibrosis. While the long term goal is to prevent and cure the disease, the main focus of present therapeutic approaches is to slow disease progression and extend the lives of patients. Numerous preclinical and clinical trials involve the investigation of pulmonary fibrosis, and therefore there is a need in the field to quantify the presence and amount of fibrotic tissue. A drug manufacturer may need to investigate whether a new drug formulation causes pulmonary fibrosis in exposed specimens. Also, new drug formulations may be investigated to determine if they reduce or prevent the formation of pulmonary fibrosis in animal models in preclinical trials following exposure to environmental agents or exposure to other drug formulations.

Traditionally, fibrosis research was limited to exposing preclinical research animal models to agents suspected to cause pulmonary fibrosis, sacrificing the animal, excising the lung tissues, and then subjecting the lung tissues to traditional histology. Under traditional histology, the lung tissue is scored to qualitatively assess the amount or extent of pulmonary fibrosis. There are three main shortcomings associated with traditional histology based methods. First, the tissue is cut into many thin slices, thus destroying it and precluding subsequent processes. Second, only a small number of the slices are assessed (the others are discarded) and consequently the heterogeneous three-dimensional distribution of fibrotic pathology throughout the specimen goes undetected. There is a need to determine the amount and extent of fibrosis without the limitations of traditional histology.

To improve the analysis of fibrotic tissue in lung tissues, the present disclosure relates to imaging lung tissues using microCT and analyzing the images beyond a qualitative determination of fibrosis. In the present disclosure, the images from microCT scanning of the stained lung tissues are analyzed in three-dimensional space and overcome the limitations of traditional histology.

### SUMMARY

Accordingly, the present disclosure provides methods for preparing, staining, and imaging lung tissues to acquire microCT images of lung tissues to be subjected to virtual histology and analysis. The present method allows for stained lung tissues to be analyzed in three dimensional space to provide a quantification of the amount of fibrotic tissue within the entire lung tissue, while preserving lung tissue integrity for future analysis. The microCT data sets or images can be subjected to processing to allow quantification of the fibrotic tissues.

### BRIEF DESCRIPTION OF THE DRAWINGS

FIG. 1A shows an exemplary microCT image of a section of normal adult mouse lung tissue, sample 154.

FIG. 1B shows an exemplary section of the same normal adult mouse lung (sample 154) as shown in FIG. 1A, which was subjected to traditional histology.

FIG. 2A shows an exemplary microCT image of a section of diseased (fibrotic) adult mouse lung tissue, sample 354.

FIG. 2B shows an exemplary section of the same diseased (fibrotic) adult mouse lung (sample 354) as shown in FIG. 2A, which was subjected to traditional histology.

FIG. 3 shows an additional exemplary microCT image of a section of normal adult mouse lung tissue, sample 52.

FIG. 4 shows an additional exemplary microCT image of a section of normal adult mouse lung tissue, sample 153.

FIG. 5 shows an additional exemplary microCT image of a section of normal adult mouse lung tissue, sample 154.

FIG. 6 shows an additional exemplary microCT image of a section of diseased (fibrotic) adult mouse lung tissue, sample 353.

FIG. 7 shows an additional exemplary microCT image of a section of diseased (fibrotic) adult mouse lung tissue, sample 354.

FIG. 8 shows an additional exemplary microCT image of a section of diseased (fibrotic) adult mouse lung tissue, sample 454.

FIG. 9 shows a histogram which illustrates the distribution of grayscale values for each voxel measured from the microCT images of FIGS. 3-8. The gray scale range is from 0 (black) to 255 (white).

FIG. 10 shows a histogram which illustrates the images as shown in the histogram of FIG. 9 which were normalized based on the size of the lungs. The data were normalized by dividing the distribution values in the histogram of FIG. 9 by the total number of voxels of the lung.

### DETAILED DESCRIPTION

Definitions

As used herein and in the appended claims, the singular form “a,” “an” and “the” include plural referents unless the context clearly dictates otherwise. Thus, for example, reference to “an agent” refers to one agent or mixtures of such agents, and reference to “the method” includes reference to equivalent steps and methods known to those skilled in the art.

Unless defined otherwise, all technical and scientific terms used herein generally have the same meaning as commonly understood by one of ordinary skill in the art to which this invention belongs. Generally, the nomenclature used herein and the laboratory procedures in cell culture, molecular genetics, organic chemistry, and nucleic acid chemistry and hybridization described below are those well-known and commonly employed in the art. The nomenclature used herein and the laboratory procedures in analytical and organic synthetic chemistry described below are those well-known and commonly employed in the art. Standard techniques, or modifications thereof, are used for chemical synthesis and chemical analysis.

As used herein, a “specimen” is a biological specimen, which encompasses cells, tissues, organs and whole organisms. The term “specimen” is used interchangeably herein with the term “sample.”

As used herein, the term “organism” refers to any living entity comprised of at least one cell. A living organism can be as simple as, for example, a single eukaryotic cell or as complex as a mammal. The term “organism” encompasses naturally occurring as well as synthetic entities produced through a bioengineering method such as genetic engineering.

As used herein, the term “tissue” includes cells, tissues, organs, blood and plasma.

The term “microCT” refers to X-ray microcomputed tomography.

The term “virtual histology” refers to methods by which specific tissues can be visualized using stains and then imaged using microCT.

Overview

The present disclosure addresses the above identified drawbacks of traditional histology. Disclosed is a method for staining, imaging, and quantifying fibrotic tissue in lung tissues using virtual histology, which is the analysis of microCT data sets and images. The present method allows for fibrotic tissue to be analyzed in three-dimensional (3-D) space, and thereby overcomes the limitation of a two-dimensional (2-D) histological slice.

According to the present disclosure, fibrotic tissue can be distinguished and segmented in multiple histological planes within individual specimens. One of the limitations of traditional histology is that a particular histological plane must be chosen prior to en bloc microtomy. Often an investigator is left to designate a “consensus” section (i.e. coronal, sagittal, or axial view) between samples in order to achieve consistency within a particular cohort, or section three separate specimens in order to derive a collective understanding of disease condition. In addition, traditional histology necessitates the destruction of the sample, while microCT preserves sample integrity and structure. In contrast, according to the disclosed methods, multiple views can be captured within the same specimen and can be comprehensively examined by a simple manual reorientation of the data set using intuitive computer controls. In addition, oblique views of the sample can be captured instantaneously and in any orientation most desirable to the observer.

The present disclosure allows for the quantitative, volumetric capture of the whole mount lung within a specimen and enriches the data provided per specimen. This allows the user to achieve greater statistical power with fewer animals. Using traditional histological methods, studies often require that multiple cohorts are bred in an experimental animal colony in order to derive single parameter statistics for a particular experiment. Not only do the disclosed methods enable the user to quantify areas of fibrotic tissue over the length and width of a lung specimen but also to quantify how deep the fibrotic region extents into the tissue. This advantage is due to the 3-D nature of the analysis as opposed to the ability of traditional histology to analyze tissue in a 2-D section. Thus, the methods disclosed herein enable researchers to perform a more thorough analysis of an entire lung from each study animal and to acquire more quantitative, as opposed to qualitative, data from the tissues.

Preparing Specimens for Imaging

Preparing the specimens for acquisition by microCT involves dissecting a specimen to remove lung tissues, then fixing the lung tissue in a fixative. Once the lung tissue has been fixed, at least one staining agent is used to stain the lung tissue, whereby additional compositions may be included to improve the contrast between the specific anatomical features.

In further embodiments, before the lungs are removed from the animal, the blood is removed from the animal, especially from the lung tissues, by methods known in the art. In a further embodiment, before the lungs are removed from the animal, blood is removed from the lung tissues.

In further embodiments, combinations of preparation methods are used to process specimens for imaging. As will be appreciated, any combination of such preparation methods described herein and known in the art can be used in accordance with the present invention. In some embodiments, staining agents are optionally combined with a buffer and/or a fixative and/or cross-linking agent and/or a reporter substrate for a reporter gene product. As will be appreciated, any combination of such materials can be used to stain specimens in accordance with the present invention.

Staining Compositions

In one aspect, the invention provides staining compositions for preparing specimens for acquisitions of images, such as microCT images. Exemplary staining agents of use in the present invention include metals such as osmium (e.g. osmium tetroxide), tungsten (e.g. phosphotungstic acid, sodium tungstate), molybdenum (e.g. ammonium molybdate, phosphomolybdic acid), the noble metals, e.g. (platinum, (e.g. cisplatin), gold (e.g. sodium chloroaurate)), bismuth, (e.g. bismuth subnitrate), cadmium (e.g. cadmium iodide), iron (e.g. ferric chloride, potassium ferricyanide, potassium ferrocyanide), indium (e.g. indium trichloride), lanthanum (e.g. lanthanum trichloride), lead (e.g. lead acetate, lead citrate, lead nitrate), ruthenium (e.g. ruthenium red), silver (e.g. silver nitrate, silver proteinate, silver tetraphenylporphyrhin), thallium (e.g. thallium nitrate), uranium (e.g. uranyl acetate, uranyl nitrate) and vanadium (e.g. vanadyl sulfate). Other appropriate metals of use in the methods of the invention will be apparent to those of skill in the art. Other exemplary staining agents of use in the present invention include phosphotungstic acid (PTA).

The staining agent is present in the staining composition in any concentration useful to provide a desired level of contrast in the image of the specimen. Appropriate concentrations of a selected staining agent are readily determinable by those of skill in the art without resort to undue experimentation. For example, arrays of staining compositions including a single staining agent are prepared. Each composition is used to stain a specimen. The level of staining of each specimen by each staining composition is determined by acquiring a microCT image of each of the stained specimens.

In an exemplary embodiment, the staining agent is present in the staining composition in an amount from about 0.01 weight percent to about 10 weight percent, preferably from about 1 weight percent to about 8 weight percent, more preferably from about 3 weight percent to about 5 weight percent.

In further embodiments, the specimen is stained in a combination of staining agents. Such a combination of staining agents may include two or more of any staining agents described herein and known in the art.

Optionally, staining compositions of the invention further include at least one buffer component. The buffer is present in any concentration that is useful to provide a desired level of staining of the specimen, as evidenced, in one embodiment, by obtaining a desired level of contrast in a microCT image of the stained tissue. A buffer that has a different osmotic concentration than the tissue is optionally used in the process of stain penetration so as to accelerate transfer of stain molecules into components of tissue, e.g. tissue cells.

Exemplary buffer concentrations for staining compositions of the invention range from about 0.01 M to about 1.0 M. In further exemplary embodiments, the buffer concentrations are in the range of about 0.05 M to about 0.90 M, about 0.10 M to about 0.80 M, about 0.20 M to about 0.70 M, about 0.30 M to about 0.60 M and about 0.40 M to about 0.50 M. In some embodiments, the buffer is a cacodylate buffer, e.g. sodium cacodylate trihydrate. In some embodiments, the buffer is a phosphate buffer. Other buffers known in the art may also be used in accordance with the present invention.

In further embodiments, staining compositions include at least one fixative or cross-linking agent component such as glutaraldehyde, formaldehyde, alcohols, or a combination of these. In exemplary staining compositions, the fixative or cross-linking agent is present in a concentration range of from about 0.05% to about 5%, preferably from about 0.1% to about 3% and more preferably from about 1% to about 1.5%.

In still further embodiments, staining compositions of the invention may also include a tissue penetration enhancing agent component. A representative tissue penetration enhancing agent is DMSO.

In still further embodiments, any combination of the above components is included in staining compositions of the present invention.

Methods of Staining Specimens

The present invention provides methods for staining intact tissue by incubation in the agent. The present inventors have found that although not traditionally thought to be able to penetrate intact tissue, certain staining agents are able to pass through tissue to stain the specimen such that the boundaries between bone and soft tissue can be differentiated using visualization methods such as microCT.

In an exemplary aspect, specimens are incubated for a selected period in a staining composition of the present invention. The period of time over which the specimen is incubated with the staining composition is readily determined by those of skill in the art and is informed by the level of contrast desired in the images acquired from the stained specimen. Incubation in staining compositions is generally conducted at ambient room temperature, but staining at higher and lower temperatures is also within the scope of the present invention.

In exemplary embodiments, the specimen is in contact with the staining compositions from about one hour to about one week. In still further exemplary embodiments, the specimen is in contact with the staining composition for about nine hours to about five days, about twelve hours to about four days, about sixteen hours to about two days and about eighteen hours to about twenty-four hours. Periods of at least about three hours, at least about five hours, at least about ten hours and at least about fifteen hours are also of use in the methods of the invention.

In further embodiments, after incubation in a staining composition, specimens are transferred to one or a series of buffer solutions so as to remove extra staining agents and to create a density contrast between the specimens and the bordering environments to facilitate distinguishing of the tissue from its bordering environment. In some embodiments, the buffer solution has a different osmolality than that of the tissue to accelerate or otherwise to have the transfer of stain molecules into a component of the specimen, e.g. tissue cells. An exemplary buffer is a buffered saline solution, e.g. phosphate buffered saline (PBS). When this subsequent osmolality differential is applied, the staining composition can be of a greater or lesser osmolality than the buffer to which the stained specimen is subsequently submitted. Buffer solutions of use in the present invention can include without limitations sodium cacodylate buffer, phosphate-buffered saline, and ethanol solutions. In specific embodiments, transfers through buffers are conducted for the same or different periods of time. In further embodiments, these transfers (also referred to herein as “washes”) through buffers are conducted for about one to about five hours.

In some embodiments, specimens are fixed prior to contact with staining compositions. In some embodiments, specimens are fixed through incubation in a formalin solution for a period of time. In some embodiments, the formalin is a 10% neutral buffered formalin solution. In further embodiments, the formalin can range from a 0.5 to a 15% neutral buffered solution. In some embodiments, the specimen is fixed for a period of about two to four days. In further embodiments, the specimen is fixed for a period of about one day to about two weeks. In still further embodiments, the specimen may be fixed for a month or longer.

In further embodiments, specimens are washed prior to, subsequent to, or both prior to and subsequent to incubation in a staining composition. In still further embodiments, specimens are washed prior to, subsequent to, or both prior to and subsequent to pre-stain fixation in solutions such as formalin. In specific embodiments, these washes are conducted in phosphate buffered saline (PBS) for about one to about five hours. In still further embodiments, multiple washes are conducted. As will be appreciated, any combination of methods and staining compositions described herein and known in the art in to prepare specimens of imaging modalities such a microCT virtual histology.

Imaging Methods

In the preferred embodiment, microCT methods of the present invention provide high resolution, non-destructive analysis of the status, integrity and development of biological tissues. In specific aspects, virtual histology methods are conducted according to methods and compositions described in U.S. patent application Ser. Nos. 12/162,376, filed Oct. 15, 2008; Ser. No. 11/575,057, filed Jan. 29, 2008; Ser. No. 11/888,995, filed Aug. 3, 2007; Ser. No. 11/839,414, filed Aug. 15, 2007; Ser. No. 12/389/094, filed Feb. 19, 2009; 61/143,380, filed Jan. 8, 2009; and 61/230,574, filed Jul. 31, 2009, each of which is hereby incorporated by reference in its entirety, including all drawings, examples, and disclosure related to microCT virtual histology imaging and processing of virtual histology images.

The sensitivity and specificity of microCT-based analysis provides a rapid and inexpensive method that enhances visualization and analysis of complex global 3-D organization. Unlike traditional histology, which requires meticulous slicing and individual examination, the methods of the present invention include staining specimens with specific staining compositions as described herein and scanning them with microcomputed tomography (microCT), which provides a high resolution image of the whole specimen without the need for the slices required in other imaging modalities. The methods of the present invention provide a digital visualization with the capability of providing a number of measurements of various anatomical features of the specimen. Such measurements include without limitation distance, area, and volume of such anatomical features.

Although the following section provides a description of embodiments in terms of microCT imaging, it will be appreciated that these methods can be adapted to other imaging technologies using methods known in the art.

A microCT image is generated, for example, using a commercially available scanner. More rapid volumetric CT scans of specimens may be performed at lower resolution, such as at 27 μm isometric voxel resolution, while longer higher resolution scans, such as 8 μm isometric voxel resolution, may also be performed, depending on the desired cost, time constraints and resolution required. Parameters such as current, voltage, number of frames per view, and exposure time are adjusted as appropriate and are kept constant for images to be compared. For each scan, a number of evenly spaced views may be averaged. The scans may be filtered, for instance to avoid saturation of the detector, using appropriate filters, such as 0.2 mm aluminum.

Images can be reconstructed using appropriate software. Preliminary visualization and virtual histology sections may be generated with the publicly available MicroView program. Isosurface renderings and volume renderings of the microCT datasets can also be generated as images.

Specimens can be scanned at resolutions from submicrons up to tens of microns. MicroCT based virtual histology matches or exceeds the tissue contrast achieved by more time and cost intensive magnetic resonance imaging, while offering much higher spatial resolution. For increased throughput of these types of studies, multiple specimens are optionally scanned simultaneously in the same field of view.

The computed tomography image of a specimen, such as an organ, may include an isosurface rendering so as to examine the exterior of the specimen for anatomical or molecular differences compared to other control specimens. In a further embodiment, the computed tomography image of the specimen may include a virtual section of the specimen.

Large numbers of images and associated data may be generated using microCT to image specimens. Such datasets represent a valuable resource for investigating effects of certain experimental procedures, such as the development of lung fibrosis. In order to facilitate access and aid in generation of a data, a computer based process for collecting, storing and retrieving microCT images and/or image data is provided according to the present invention. In one embodiment such a process includes the steps of generating a digital computed tomography image, electronically transmitting the image and/or data to a centralized data storage location associated with a computer, retrieving the image and/or data from the storage location in response to a request and electronically displaying or transmitting the image and/or data, and/or analysis of the image and/or data to a second location in response to the request.

A generated computed tomography image and/or data for generating such an image may be stored electronically, in memory circuitry such as a database, and/or on a computer readable storage medium. A generated computed tomography image is communicated to a repository for such images, a centralized image and/or image data storage location associated with a computer. Such images and data for image generation may be generated and communicated from multiple locations for centralized storage.

Communication of generated images and/or image data may be conducted over a wired or wireless connection to a device or system configured as a server or computer network accessible by multiple users from multiple locations. The server or computer network may include any type of computer device or devices such as a portable device or personal computer, workstation, or mainframe computer.

Processing and memory circuitry is included in the server or computer network such that an image and/or image data may be communicated to memory circuitry and stored. Further, the stored information may be retrieved from the memory circuitry. Optionally included is a comparison program executable by the circuitry to carry out a comparison of the one image or set of images with another set of images in order to characterize differences between the images relating to anatomical and/or molecular differences in specimens imaged. Such a comparison program may be stored and executed on a server or computer network which also includes the stored image and/or image data. A comparison program may also be stored and executed by a separate device to which images and/or image data retrieved from the memory circuitry of the server or computer network are downloaded.

An image and/or data for generating an image may be retrieved from the centralized storage location in response to a request. For example, a user inputs information to a device and output capacity to communicate a request to retrieve an image and/or image data from the server or computer network storage location. The image and/or data may be displayed to the user and/or downloaded to the user's device. Further, the retrieved image and/or data may be retrieved for analysis and results of the analysis displayed or downloaded by the user.

In some embodiments, the microCT data sets or images are normalized in order to account for variation, for example, of lung inflation, specimen size, and stain concentration. The distribution of microCT measurement values can be assessed be creating a histogram of those values. In practice, fibrotic tissue tends to be hyperattenuating or brightest which is reflected in the shape of the histogram. The present invention allows for quantification of these gray scale values to determine the amount of hyperattenuated areas, which was found to be associated with stained fibrotic tissues.

In some embodiments, multiple images of different specimens or multiple images taken at different areas of the same specimen will be compared to identify differences and similarities in anatomical features, such as the presence of fibrotic tissue. In such embodiments, methods can be used to ensure that the images are co-registered to identify points in each image which correspond to points in other images. Registration of images is a fundamental task in image processing used to match two or more images, for example at different times, from different sensors, or from different viewpoints. Also, co-registration can be accomplished between virtual histology and traditional histology.

Herein, a method to detect, evaluate, and quantify fibrotic tissue in biological tissue specimens, where the biological tissue is stained and imaged using X-ray microcomputed tomography (microCT) is disclosed. In certain embodiments, a method of detecting fibrosis in a tissue specimen includes the steps of incubating the tissue specimen in at least one staining agent to produce a stained tissue specimen, scanning the stained tissue specimen in an X-ray computer tomography scanner and producing a microCT image of the stained tissue specimen, and analyzing the microCT image to determine if fibrosis is present in the tissue specimen.

In some embodiments the tissue specimen is lung tissue specimen. Alternatively, the tissue specimen is a liver specimen, a kidney specimen, or any other tissue specimen in which fibrosis may develop. In some embodiments the at least one staining agent includes a metal that is selected from at least one of osmium, tungsten, molybdenum, platinum, gold, bismuth, cadmium, iron, indium, lanthanum, lead, ruthenium, silver, thallium, uranium, or vanadium. In another embodiment the one or more staining agents include phosphotungstic acid. In some embodiments, one or more staining agents is present in an amount of from about 0.01 weight percent to about 10 weight percent.

After incubating the tissue in the one or more staining agents, the tissue specimen may be further transferred to at least one buffer solution which comprises a different osmolality than that of the tissue specimen. In an embodiment, the method of detecting fibrosis in a tissue specimen includes a step of transferring the tissue to at least one buffer solution which comprises a different osmolality than that of the tissue specimen. In some embodiments, the concentration of the at least one buffer is from about 0.01 M to about 1.0 M. In some embodiments, the at least one buffer solution is selected from at least one of a cacodylate buffer, a phosphate buffer, or an ethanol solution.

In some embodiments, the method of detecting fibrosis in a tissue specimen includes a step of fixing the tissue specimen in at least one fixative. In certain embodiments, the fixative is selected from at least one of glutaraldehyde, formaldehyde, or an alcohol. In some embodiments, the at least one fixative is present in a concentration of from about 0.05% to about 5%.

In addition, disclosed herein is a method of visualizing fibrotic tissue in a tissue specimen, which includes the steps of incubating the tissue specimen in a staining agent to produce a stained tissue specimen, scanning the stained tissue specimen in an X-ray computer tomography scanner to produce a microCT image of the stained tissue specimen, and reconstructing the microCT image to visualize fibrotic tissue in the stained tissue specimen.

In some embodiments of this method, the tissue specimen comprises a lung tissue specimen. In some embodiments, the staining agent includes a metal that is selected from at least one of osmium, tungsten, molybdenum, platinum, gold, bismuth, cadmium, iron, indium, lanthanum, lead, ruthenium, silver, thallium, uranium, or vanadium osmium, tungsten, molybdenum, platinum, gold, bismuth, cadmium, iron, indium, lanthanum, lead, ruthenium, silver, thallium, uranium, or vanadium. Alternatively, the staining agent may include phosphotungstic acid. In some embodiments the staining agent is present in an amount of from about 0.01 weight percent to about 10 weight percent.

Also disclosed herein is a method for quantifying fibrosis within a tissue specimen, which includes the steps of producing a microCT image of a stained tissue specimen by incubating the tissue specimen in at least one staining agent to produce a stained tissue specimen, scanning the stained tissue specimen in an X-ray computer tomography scanner to produce a microCT image of the stained tissue specimen, and quantifying a distribution of grayscale values for each voxel measured from the microCT image, wherein a measure of elevated grayscale values is indicative of a region of fibrotic tissue.

In one embodiment of the method, an additional step of generating virtual histology sections is present. In certain embodiments, the grayscale values are normalized to a defined parameter associated with the stained tissue specimen. In further embodiments, the data are normalized by dividing the grayscale values by the total number of voxels in microCT image of the stained tissue specimen. In some embodiments, the staining agent hyperattenutates in fibrotic tissues to differentiate between fibrotic tissue and non fibrotic tissue.

### EXAMPLE 1

This study combined the features of microCT and advanced imaging software to allow for the visualization and quantification of fibrotic lung tissue in induced mouse models. Mice were dosed by implantation of osmotic micropumps to deliver bleomycin for seven days. The pumps were removed and mice were allowed to ambulate freely for five weeks. After sacrificing the mice, the lungs were flushed with intracardial perfusion of heparinized saline to facilitate blood clearance. The intact lungs were then excised from the mice and prepared for imaging. The excised lung tissues were submerged in 10% Buffered Formalin (Electron Microscopy Sciences, 15742-60) for at least seven days. The excised lung tissues were removed from the fixative solution and submerged in 5% phosphotungstic acid (Electron Microscopy Sciences, 19502-5) for at least four days.

The microCT generated DICOM files were analyzed and used to create volume renderings of the entire excised lungs. The raw data files were reoriented and cropped using AltaViewer (Numira Biosciences Inc., Salt Lake City, Utah), and then converted into a file format compatible with the segmentation software, LabVH (Numira Biosciences Inc., Salt Lake City, Utah). The total tissue volume and the hyperattenuating tissue volume were quantified for both normal lung samples and fibrotic lung samples.

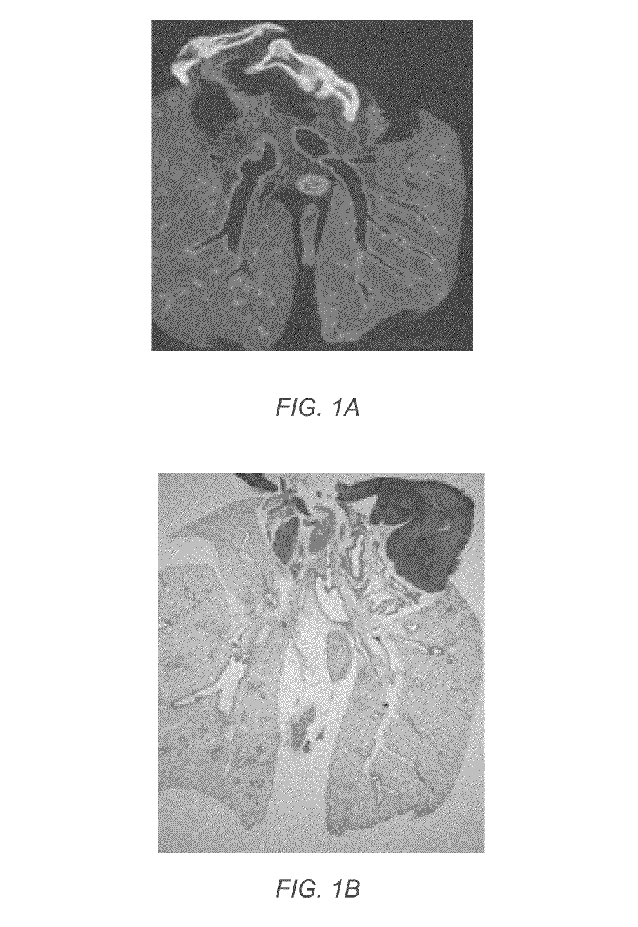

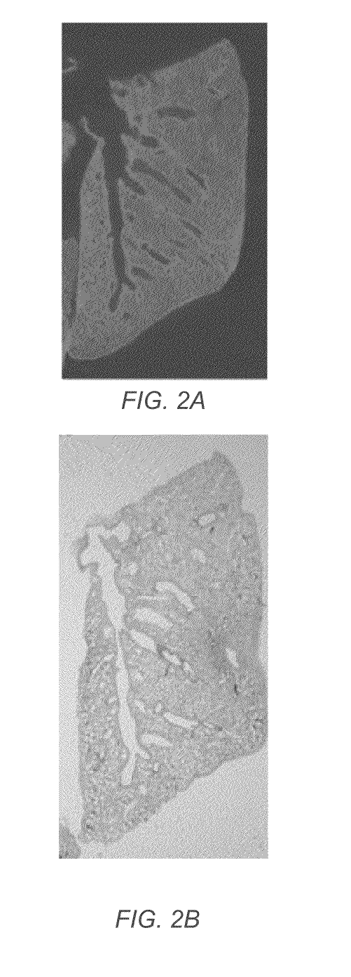

Fibrotic tissue samples had a significantly higher ratio of hyperattenuating regions to total volume than normal lung samples. To assess whether the hyperattenuating regions correspond to fibrotic tissue, the samples were submitted for histology post microCT imaging. FIGS. 2A and 2B depict a representative data set, where the microCT image (FIG. 2A) and comparable histology photomicrograph (FIG. 2B) are shown for a single 2-D section. Histology confirmed that hyperattenuating regions observed by microCT corresponded to fibrotic regions by Masson's trichrome stain. A representative control sample is shown in FIGS. 1A and 1B. Although the normal sample also showed regions of hyperattenuation, the ratio of hyperattenuation volume to total volume was significantly lower. These data are reported in Table 1 wherein the fibrotic lung is represented by sample number 354 and the normal control lung is represented by sample number 154

### EXAMPLE 2

Prior to staining and scanning, mice were dosed by subcutaneous implantation of micropumps to deliver bleomycin for seven days, then the pumps were removed and mice were allowed to ambulate freely for five weeks. Mice were then sacrificed and the lungs were flushed with intracardial perfusion of heparinized saline to facilitate blood clearance. The mouse tissues were fixed with intracardial perfusion of neutral buffered formalin to maintain vascular integrity. Lungs were then excised from the mice and stained as described in Example 1.

The lung specimens were staged in a microCT scanner (Scanco μCT, SCANCO, USA, Southeastern PA) and scanned at 10 μm isotropic resolution. The microCT-generated DICOM files were used to analyze the samples and to create volume renderings of the regions of interest, the entire excised lungs. The raw data files were reoriented and cropped using AltaViewer (Numira Biosciences Inc., Salt Lake City, Utah). The files were converted into a file format compatible with the segmentation software, Seg3D (Scientific Computing and Imaging Institute, University of Utah, Salt Lake City, Utah). Seg3D was used to create label maps associated with the regions of interest. The volume rendering snapshots of the segmented regions were saved using SCIRun (Scientific Computing and Imaging Institute).

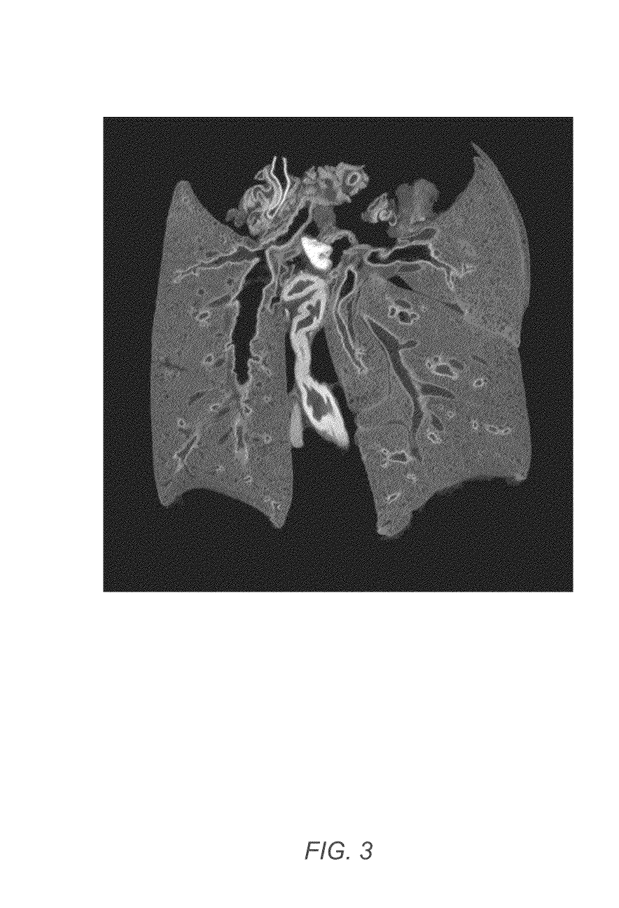

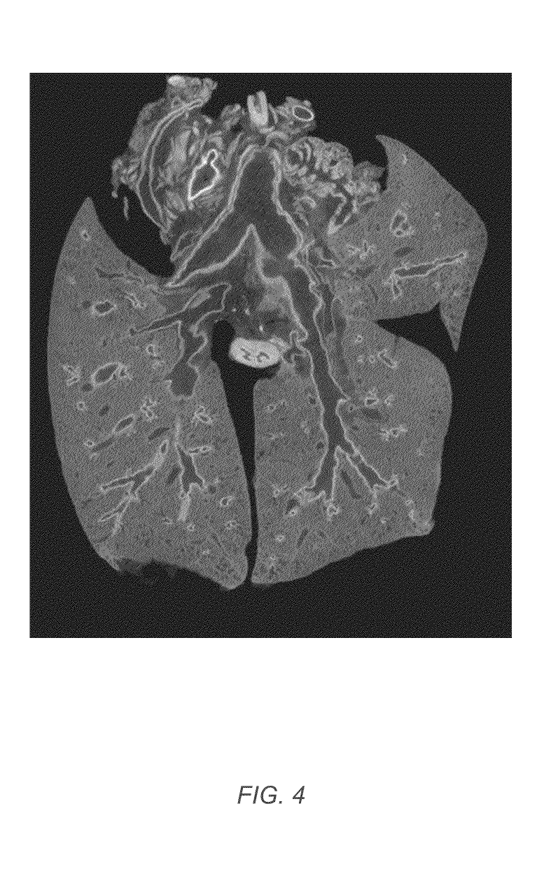

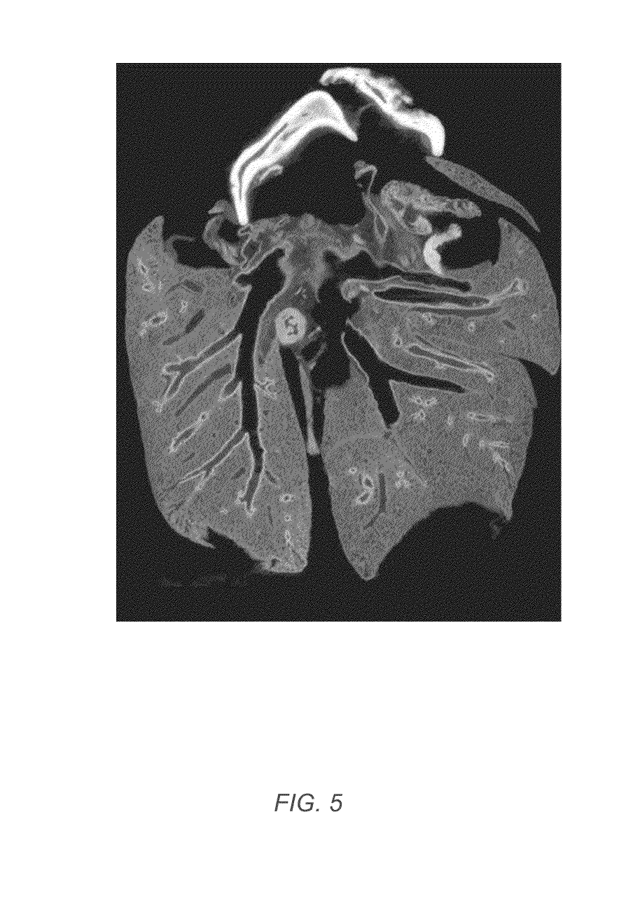

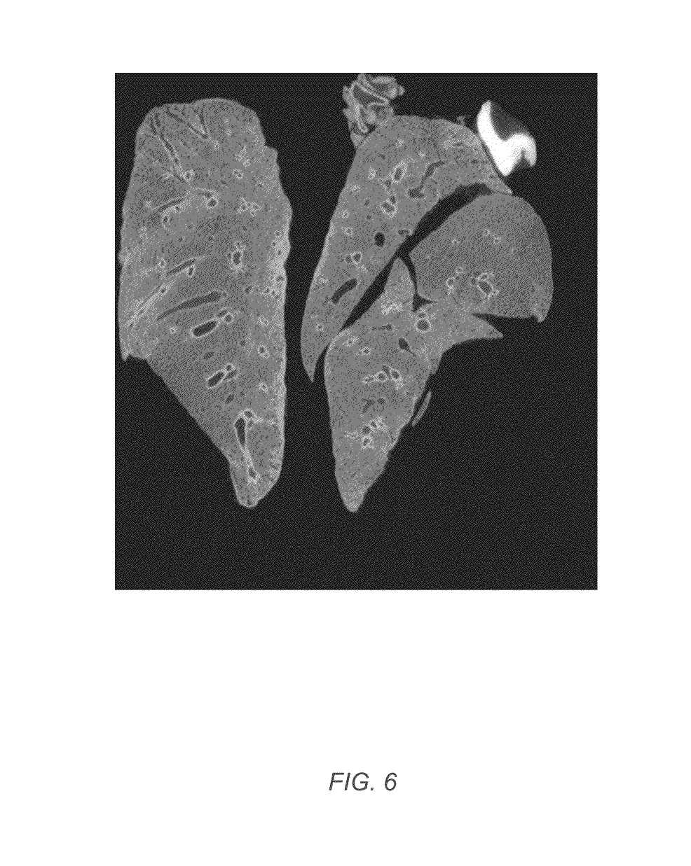

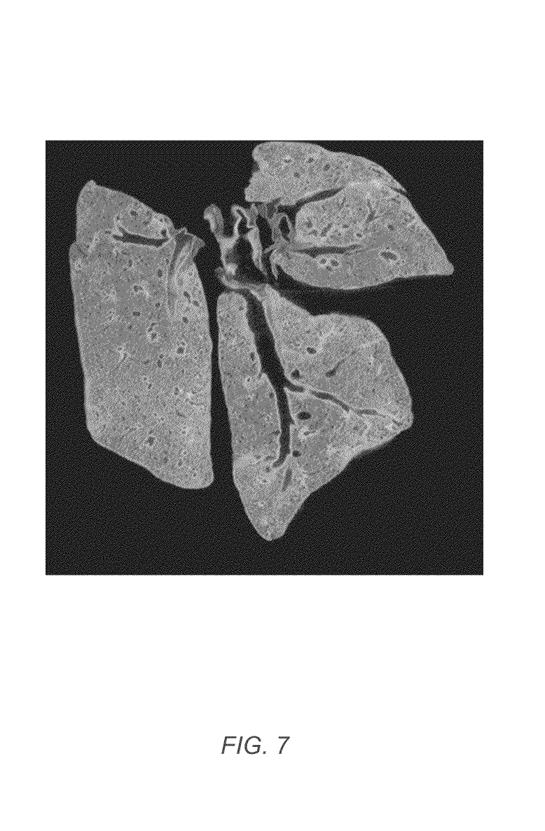

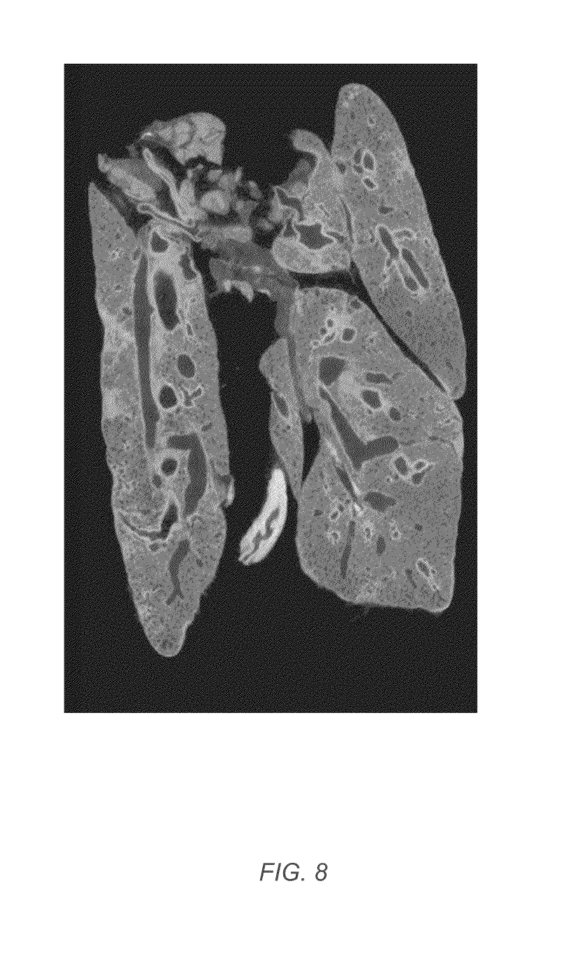

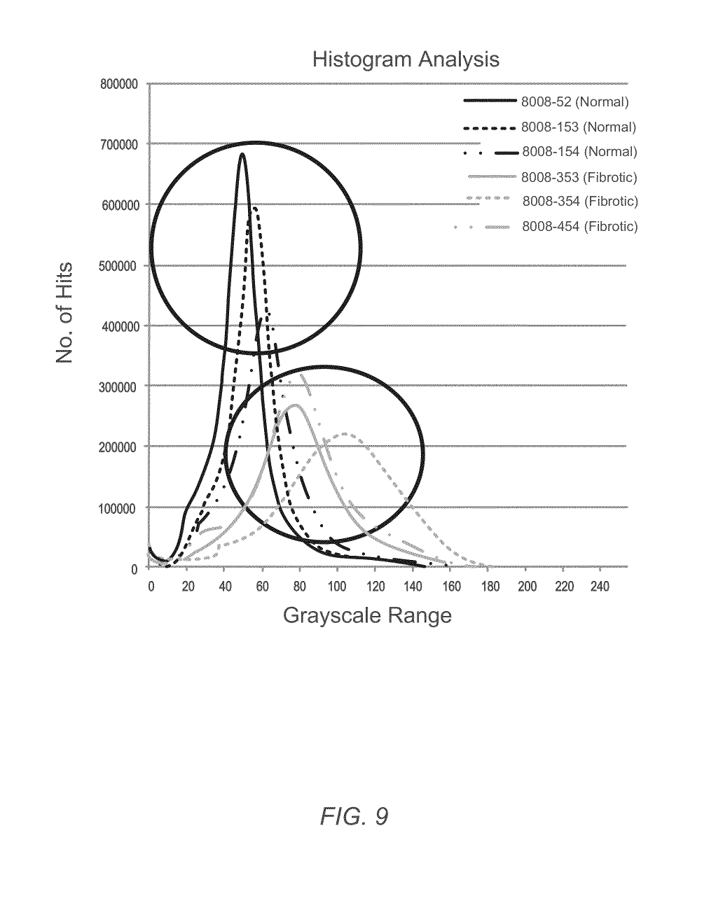

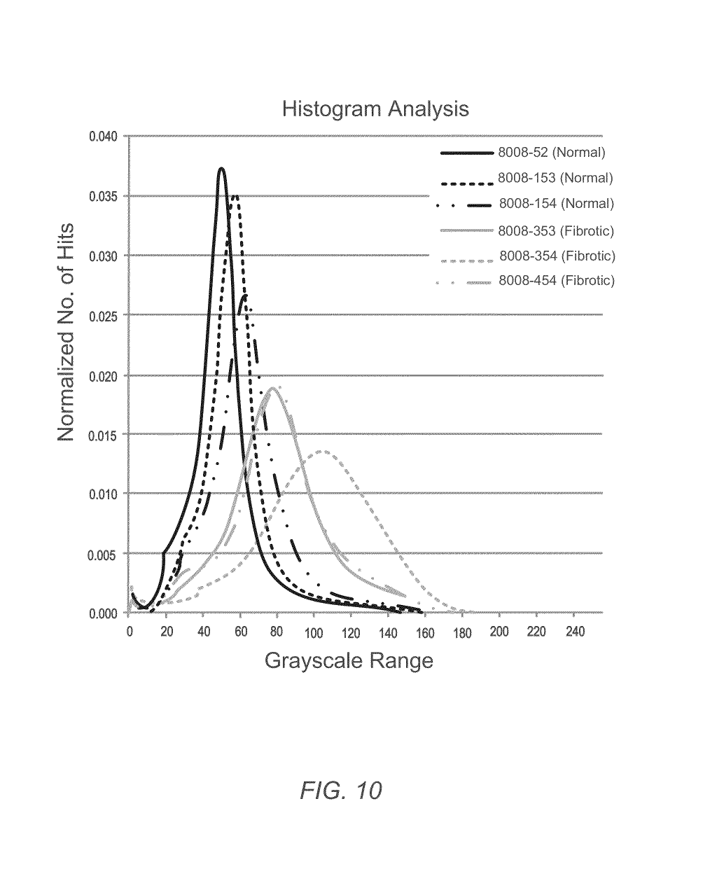

Fibrotic formation in representative regions of the lungs was non-destructively captured. MicroCT analysis of the excised lungs, both normal and bleomycin induced, allowed visualization of the location and thickness of hyperattenuating fibrotic tissues. FIGS. 6-8 display 2-D images of diseased model lungs, visualizing fibrotic pulmonary tissues. The images display the hyperattenuating regions. For comparison, FIGS. 3-5 display similar images of normal adult mouse lungs. Visually, a noticeable difference exists between the two sample types, however, quantifiable data, reported in Table 1, provides more information.

TABLE 1
Reported Values for Normal and Fibrotic Lung Samples

| | Total Tissue | ‘Bright’ Tissue | Ratio |
|---|---|---|---|
| Sample No | Volume (mm³) | Volume (mm³) | (BTV/TTV) |
| 52 (Normal) | 242.493 | 1.682 | 0.007 |
| 153 (Normal) | 220.171 | 2.292 | 0.01 |
| 154 (Normal) | 210.557 | 3.927 | 0.019 |
| 353 (Fibrotic) | 187.963 | 9.708 | 0.052 |
| 354 (Fibrotic) | 212.73 | 36.878 | 0.173 |
| 454 (Fibrotic) | 219.508 | 13.328 | 0.061 |

The embodiments of the present invention described above are intended to be merely exemplary and those skilled in the art will recognize, or be able to ascertain using no more than routine experimentation, numerous equivalents to the specific procedures described herein. All such equivalents are considered to be within the scope of the present invention and are covered by the following claims. The contents of all references described herein are hereby incorporated by reference. Other embodiments are within the following claims.

We claim:

1. A method for detecting fibrosis in a tissue specimen, the method comprising:
a) incubating the tissue specimen in at least one staining agent to produce a stained tissue specimen;
b) scanning the stained tissue specimen in an X-ray computer tomography scanner, thus producing a microCT image of the stained tissue specimen; and
c) analyzing the image to determine if fibrosis is present in the tissue specimen.

2. The method of claim 1, wherein the tissue specimen comprises a lung tissue specimen.

3. The method of claim 1, wherein the at least one staining agent comprises a metal that is selected from at least one of osmium, tungsten, molybdenum, platinum, gold, bismuth, cadmium, iron, indium, lanthanum, lead, ruthenium, silver, thallium, uranium, or vanadium.

4. The method of claim 1, wherein the at least one staining agent comprises phosphotungstic acid.

5. The method of claim 1, wherein the at least one staining agent is present in an amount from about 0.01 weight percent to about 10 weight percent.

6. The method of claim 1, further comprising the step of transferring the tissue to at least one buffer solution which comprises a different osmolality than that of the tissue specimen.

7. The method of claim 6, wherein the concentration of the at least one buffer is from about 0.01 M to about 1.0 M.

8. The method of claim 6, wherein the at least one buffer solution is selected from at least one of a cacodylate buffer, a phosphate buffer, or an ethanol solution.

9. The method of claim 1, further comprising the step of fixing the tissue specimen in at least one fixative.

10. The method of claim 9, wherein the at least one fixative is selected from at least one of glutaraldehyde, formaldehyde, or an alcohol.

11. The method of claim 9, wherein each of the at least one fixative is present in a concentration of from about 0.05% to about 5%.

12. A method of visualizing fibrotic tissue in a tissue specimen, the method comprising:
a) incubating the tissue specimen in a staining agent to produce a stained tissue specimen;
b) scanning the stained tissue specimen in an X-ray computer tomography scanner, thereby producing a microCT image of the stained tissue specimen; and
c) reconstructing the microCT image to visualize fibrotic tissue in the stained tissue specimen.

13. The method of claim 12, wherein the tissue specimen comprises a lung tissue specimen.

14. The method of claim 12, wherein the staining agent comprises a metal that is selected from at least one of osmium, tungsten, molybdenum, platinum, gold, bismuth, cadmium, iron, indium, lanthanum, lead, ruthenium, silver, thallium, uranium, or vanadium.

15. The method of claim 12, wherein the staining agent comprises phosphotungstic acid.

16. The method of claim 12, wherein the staining agent is present in an amount from about 0.01 weight percent to about 10 weight percent.

17. A method for quantifying fibrosis within a tissue specimen, the method comprising:
a) producing a microCT image of a stained tissue specimen by incubating the tissue specimen in at least one staining agent to produce a stained tissue specimen;
b) scanning the stained tissue specimen in an X-ray computer tomography scanner, thus producing a microCT image of the stained tissue specimen; and
c) quantifying a distribution of grayscale values for each voxel measured from the microCT images, wherein a measure of elevated grayscale values is indicative of a region of fibrotic tissue.

18. The method of claim 17, further comprising the step of generating virtual histology sections.

19. The method of claim 17, wherein the grayscale values are normalized to a defined parameter associated with the stained tissue specimen.

20. The method of claim 19, wherein the data are normalized by dividing the grayscale values by the total number of voxels in microCT image of the stained tissue specimen.

21. The method of claim 17, wherein the staining agent hyperattenutates in fibrotic tissues to differentiate between fibrotic tissue and non fibrotic tissue.
